(19) United States
(12) Patent Application Publication
(10) Pub. No.: US 2025/0321040 A1
(43) Pub. Date: Oct. 16, 2025

(54) SNOW SHOWER

(71) Applicant: Klafs GmbH, Schwäbisch Hall (DE)

(72) Inventor: Markus Gäbele, Schwäbisch Hall (DE)

(21) Appl. No.: 19/089,290

(22) Filed: Mar. 25, 2025

(30) Foreign Application Priority Data
Apr. 10, 2024 (EP) 24169477.7

(51) Int. Cl. F25C 3/00

(52) U.S. Cl. CPC F25C 3/00; F25C 2303/048

(57) ABSTRACT

A snow shower is provided with a shower area, a snow machine and a chute. The snow machine has a first connection to the chute, and the chute is directed towards the shower area, such that the snow machine produces snowflakes that enter the chute through the first connection and exit the chute to fall onto the shower area. A cold nebulizer produces water mist with a temperature below 15° C., including but not limited to below 10° C., further including but not limited to between 2° C. and 8° C. The cold nebulizer produces the water mist so that it falls onto the shower area.

### CROSS REFERENCE

This application claims priority to EP application Ser. No. 24/169,477.7, filed Apr. 10, 2024, the entirety of which is hereby incorporated by reference.

### FIELD OF THE INVENTION

The present invention relates to a snow shower comprising a shower area, a snow machine and a chute, wherein the snow machine comprises a first connection to the chute and the chute is directed towards the shower area, such that the snow machine is able to produce snowflakes that enter the chute through the first connection and exit the chute through a chute exit to fall onto the shower area.

### BACKGROUND OF THE INVENTION

Cool or cold showers are used, for example, to cool down after a sauna session.

### BRIEF DESCRIPTION OF THE DRAWINGS

In the following, two example embodiments of a snow shower are explained in more detail with reference to drawings.

In the drawings:

FIG. 1 shows a schematic side view of a cut through a first embodiment of the snow shower.

FIG. 2 shows a schematic side view of a cut through a second embodiment of the snow shower.

### DETAILED DESCRIPTION OF THE DRAWINGS

A snow shower comprises a cold nebulizer that is able to produce water mist with a temperature below 15° C., including but not limited to below 10° C., further including but not limited to between 2° C. and 8° C., such that water mist falls onto the shower area.

By the combination of cold water mist and snowflakes falling towards the shower area, the shower experience can be improved. Especially, the cold perception is significantly enhanced by the combination in an unexpected way, wherein also the overall cooling rate of a user taking a shower is increased.

Advantageous embodiments of the present invention are the subject matter of the subclaims.

According to an example embodiment, the cold nebulizer is arranged such that the water mist and the snowflakes mix before impacting the shower area.

According to an example embodiment, the cold nebulizer comprises a second connection to the chute, such that the water mist enters the chute through the second connection and exits the chute through the chute exit to fall onto the shower area. This enables a compact and efficient construction of the snow shower.

In an example embodiment, the cold nebulizer is an ultrasonic nebulizer. This allows a very efficient production of water mist at the required temperature. The ultrasonic nebulizer may be fed with purified water. This increases the longevity of the ultrasonic nebulizer. The cold nebulizer may have a maximal output of at least 1.5 kg/h, including but not limited to at least 2 kg/h, including but not limited to 5 kg/h. Further, an average droplet size of the water mist may be between 2 and 15 μm, including but not limited to between 5 and 10 μm. Such a water mist is particularly suitable for the snow shower.

In an example embodiment, the snow shower comprises at least one second cold nebulizer that produces water mist with a temperature below 15° C., including but not limited to below 10° C., further including but not limited to between 2° C. and 8° C., and that is configured such that the water mist falls onto the shower area. The at least one second cold nebulizer may comprise at least one fourth connection to the chute, such that the water mist produced by the at least one second cold nebulizer enters the chute through the at least one fourth connection and exits the chute through the chute exit to fall onto the shower area. Further the at least one second cold nebulizer may be an ultrasonic nebulizer that has a maximal output of at least 1.5 kg/h, including but not limited to at least 2 kg/h, including but not limited to 5 kg/h.

In an example embodiment, the snow machine comprises a cooled rotatable cylinder and a scraper and is configured such that water or water droplets are applied to a lateral surface of the cooled rotatable cylinder at a location, the water or the water droplets then freezes to ice and the scraper then scrapes the ice off at a different location so that the snowflakes are formed. This way the snowflakes can be produced in a very energy and water efficient way. Further, the noise level of such a snow machine is relatively low. The water may be applied to the lateral surface by a water bath through which the cooled rotatable cylinder is moved at the location.

In an example embodiment, the snow shower comprises a room in which the shower area is arranged. The chute may be arranged at a ceiling or a wall of the room and the shower area is arranged below the chute. The room may be a closed cabin in a bigger room or the snow shower is configured as a walk-in shower. The room may be a room in which the walk-in shower is arranged. The chute may be arranged at the ceiling and aligned vertically. This simplifies the assembly and the snowflakes and water mist is also directed towards shower area by gravity without hindrance, as soon as they enter the chute.

The room may comprise a cooling, which is configured to cool the room to a temperature below 15° C., including but not limited to below 10° C., further including but not limited to between 2° C. and 8° C. This enhances the shower experience and improves the cooling effect. The cooling may be configured as an ice wall. An ice wall comprises a panel that is installed at a wall or ceiling area, through which a supercooled coolant is pumped, such that a surface temperature of the panel is below the freezing point of water. This creates a natural layer of real ice on the surface in humid surroundings. This allows the room to be cooled in a way that is highly resource-efficient.

In an example embodiment, the snow shower comprises a blower that comprises a third connection to the chute such that the blower is able to suck cold air with a temperature below 15° C., including but not limited to below 10° C., further including but not limited to between 2° C. and 8° C., from a cold air supply and blows the cold air through the third connection such that the cold air enters the chute through the third connection and exits the chute through the chute exit onto the shower area. Thereby, the convective heat transfer between a user's body and its surroundings can be enhanced, which changes the shower experience. Further, the speed of the snowflakes and water mists impacting the user can also be adapted this way.

The first connection and second connection may be arranged below the third connection at the chute. This arrangement is advantageous for influencing the speed of the water mist and snowflakes by the speed of the cold air.

In an example embodiment, the cold air supply is a heat exchanger that draws in ambient air and cools it down to produce the cold air.

In another example embodiment, the room is used as the cold air supply. An air duct is connected between the room and the blower, such that the blower sucks the cold air from the room.

In an example embodiment, the blower produces a volume flow rate of the cold air of up to 150 m³/h, including but not limited to up to 250 m³/h. Surprisingly, it was found that this level of volume flow rate creates a particularly good shower experience.

In an example embodiment, the snow machine produces snowflakes with a volume production rate of up to 0.05 m³/h, including but not limited to up to 0.15 m³/h. Surprisingly, it was found that this level of volume production rate creates a particularly good shower experience.

In an example embodiment, the snow shower comprises a control unit that is configured such that a user of the snow shower can switch on and off the snow machine and the cold nebulizer separately or together. The control unit may be arranged such that the user can operate the control unit being located in the shower area.

In an example embodiment, the control unit is configured such that the user of the snow shower can switch on and off the snow machine, the cold nebulizer and the blower separately or together. The control unit may be configured such that the user can control the output of the cold nebulizer and the volume flow rate of the cold air of the blower.

In the following Figures, identical parts are identified by the same reference signs. Insofar as a Figure contains reference signs which are not explicitly referred to in the associated Figure description, reference is made to preceding or subsequent Figure descriptions.

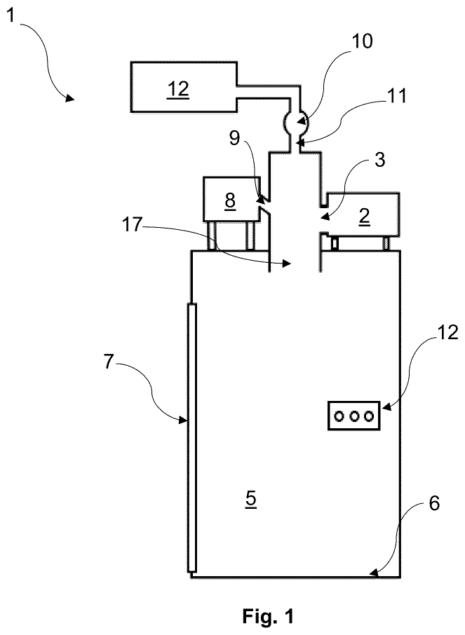

FIG. 1 shows a first embodiment of a snow shower 1 according to the invention. The snow shower 1 comprises a snow machine 2, wherein the snow machine 2 comprises a first connection 3 to a chute 4. This chute 4 is arranged at ceiling of a room 5 and a chute exit 17 is directed towards a shower area 6 at the floor of the room 5. In this embodiment, the room 5 is a cabin with a door 7. The snow machine 2, the first connection 3 and the chute 4 are configured, such that the snow machine 2 is able to produce snowflakes that enter the chute 4 through the first connection 3 and exit the chute 4 through the chute exit 17 to fall onto the shower area 6. In this embodiment, the chute 4 is formed as a straight chute and is aligned vertically.

Further, the snow shower 1 according to the first embodiment comprises a cold nebulizer 8 that is able to produce water mist with a temperature below 10° C. This cold nebulizer 8 comprises a second connection 9 to the chute 4, such that the water mist produced by the cold nebulizer 8 enters the chute 4 through the second connection 9 and exits the chute 4 through the chute exit 17 to fall onto the shower area 6.

In addition, the snow shower 1 comprises a blower 10 that comprises a third connection 11 to the chute 4. The blower 10 is configured such that the blower 10 is able to suck cold air with a temperature below 10° C. from a cold air supply, wherein the cold air supply of the first embodiment is a heat exchanger 12 that draws in ambient air and cools it down to produce the cold air. The blower 10 then blows the cold air through the third connection 11 such that the cold air enters the chute 4 and exits the chute 4 through the chute exit 17 onto the shower area 6. In this embodiment, the first connection 3 and the second connection 9 are arranged at a similar height but different sides of the chute 4. The third connection 11 is arranged above the first connection 3 and the second connection 9 at the top of the chute 4.

The snow shower 1 according to the first embodiment comprises a control unit 13 that is accessible by a user located in the shower area 6 and by which the user can switch on and off the snow machine 2, the cold nebulizer 8 and the blower 10.

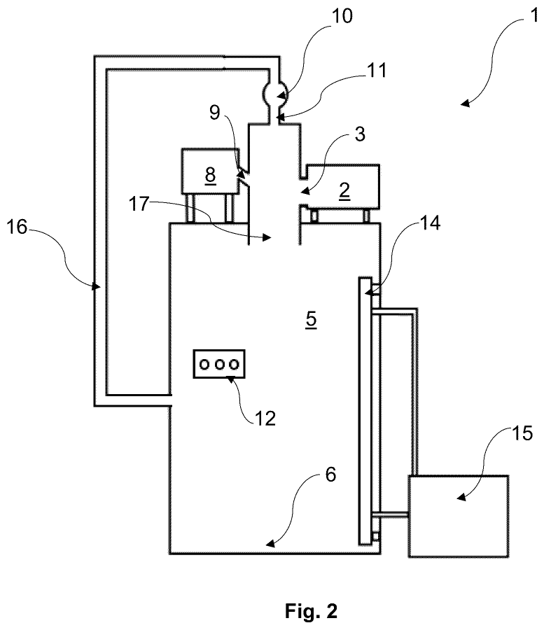

FIG. 2 shows a second embodiment of the snow shower 1 according to the invention. The second embodiment of the snow shower 1 also comprises a snow machine 2, a cold nebulizer 8 and a blower 10 all connected to the chute 4. Contrary to the first embodiment, the room 5 of the snow shower 1 of the second embodiment is cooled by an ice wall 14 to a temperature below 10° C. The ice wall 14 is a panel mounted on a wall of the room 5 that is cooled by a supercooled coolant. The supercooled coolant is pumped through the ice wall 14 by an ice wall heat exchanger 15. The blower 10 is connected to the room 5 by an air duct 16, such that the room 5 functions as the cold air supply and the cold air is circulated by the blower 10 via the room 5, air duct 16, third connection 11 and chute 4.

Further, the control unit 13 of the second embodiment is adapted such that the volume flow rate of the blower 10 and the water mist output of the cold nebulizer can be adjusted so that the control goes beyond switching on and off.

### LIST OF REFERENCE SIGNS

1 snow shower
2 snow machine
3 first connection
4 chute
5 room
6 shower area
7 door
8 cold nebulizer
9 second connection
10 blower
11 third connection
12 heat exchanger
13 control unit
14 ice wall
15 ice wall heat exchanger
16 air duct
17 chute exit

1. A snow shower comprising:
a shower area;
a chute directed toward the shower area, the chute having a chute exit; and
a snow machine including a first connection to the chute, the snow machine producing snowflakes that enter the chute through the first connection and exit the chute through the chute exit to fall onto the shower area; and
a cold nebulizer producing water mist that falls onto the shower area, the water mist having a temperature below 15° C.

2. The snow shower according to claim 1, wherein the cold nebulizer is arranged such that the water mist and the snowflakes mix before impacting the shower area.

3. The snow shower according to claim 1, wherein the cold nebulizer includes a second connection to the chute, such that the water mist enters the chute through the second connection and exits the chute to fall onto the shower area.

4. The snow shower according to claim 1, wherein the cold nebulizer is an ultrasonic nebulizer.

5. The snow shower according to claim 1, further comprising a cooled rotatable cylinder and a scraper, wherein water or water droplets are applied to a lateral surface of the cooled rotatable cylinder at a location, the water or the water droplets then freezes to ice, wherein the scraper scrapes the ice off at a different location so that the snowflakes are formed.

6. The snow shower according to claim 3, further comprising a room in which the shower area is arranged, wherein the chute is arranged at a ceiling or a wall of the room and the shower area is arranged below the chute.

7. The snow shower according to claim 6, wherein the room comprises a cooling to cool the room to a temperature below 15° C.

8. The snow shower according to claim 7, further comprising a blower with a third connection to the chute, wherein the blower sucks cold air with a temperature below 15° C. from a cold air supply and blows the cold air through the third connection such that the cold air enters the chute through the third connection and exits the chute through the chute exit onto the shower area.

9. The snow shower according to claim 8, wherein the first connection and second connection are arranged below the third connection at the chute.

10. The snow shower according to claim 8, wherein the cold air supply is a heat exchanger that draws in ambient air and cools it down to produce the cold air.

11. The snow shower according to claim 8, wherein the room is used as the cold air supply, wherein an air duct is connected between the room and the blower, such that the blower sucks the cold air from the room.

12. Snow shower according claim 8, wherein the blower produces a volume flow rate of the cold air of up to 250 m³/h.

13. The snow shower according to claim 1, wherein the snow machine produces snowflakes with a volume production rate of up to 0.15 m³/h.

14. The snow shower according to claim 8, further comprising a control unit that is configured to accept an input from a user to turn on and off the snow machine and the cold nebulizer separately or together.

15. The snow shower according to claim 14, wherein the control unit is configured to accept an input from a user to switch on and off the snow machine, the cold nebulizer and the blower separately or together.

16. The snow shower according to claim 4, wherein the cold nebulizer has a maximal output of at least 1.5 kg/h.

17. The snow shower according to claim 6, wherein the chute is arranged at the ceiling and is aligned vertically.

18. The snow shower according to claim 7, wherein the cooling is an ice wall.

19. The snow shower according to claim 14, wherein the control unit is arranged such that the control unit can accept inputs from the user while the user is located in the shower area.

20. The snow shower according to claim 15, wherein the control unit is configured to accept inputs from the user to control an output of the cold nebulizer and a volume flow rate of cold air of the blower.
